(19) United States
(12) Patent Application Publication
(10) Pub. No.: US 2005/0278230 A1
(43) Pub. Date: Dec. 15, 2005

(54) Server and service method

(75) Inventors: Hajime Shirasaka, Ashigara-Kami-Gun (JP); Tetsuya Matsumoto, Ashigara-Kami-Gun (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/148,229

(22) Filed: Jun. 9, 2005

(30) Foreign Application Priority Data
Jun. 9, 2004 (JP) 2004-171334

(51) Int. Cl. G06F 17/60

(52) U.S. Cl. 705/26

(57) ABSTRACT

The server comprises: an uploading device which receives an uploading of an image to be printed; a first database which manages additional information related to the image; an access information generating device which generates access information necessary in order for a user terminal to acquire the additional information via a network; a print instruction information creating device which creates instruction information whereby the access information and the image are recorded on a same print medium by a prescribed printer; an access information receiving device which receives the access information inputted to the user terminal according to the print medium from the user terminal; a second database which manages advertisement information; and a downloading device which, when the access information is received from the user terminal, downloads the advertisement information to the user terminal of an access source, the advertisement information being downloaded together with the additional information corresponding to the access information.

### BACKGROUND OF THE INVENTION

1. Field of the Invention

The present invention relates to a server and service method, and more particularly to a server and service method for delivering information to a user terminal of access source when access is performed by a user terminal via a network.

2. Description of the Related Art

A photographic print on which a beautiful image is printed can make a pleasure by being looked at. However, not only enjoying such an image besides by simply looking at it, it is unique to provide another pleasant method using a network. In addition, because this method successfully accelerates the use of photographic printing and communication, it would contribute to the industrial development.

When a service is provided to a user whereby information relating to an image printed on a photographic print is distributed using a network, the cost to maintain the system for registering and managing the information in a database rises. Therefore, it is necessary to charge further more the printing cost to the user, so that the user can no longer utilize the service at a low price.

In Japanese Patent Application Publication No. 2004-30302, it is described that the charge for printing is reduced by adding an advertisement to information which is acquired by the portable electronic device and performing printing.

In Japanese Patent Application Publication No. 2002-118680, it is described that a two-dimensional barcode such as a QR code (registered trademark) which is printed on an advertising medium and distributed to a general user is read by using a mobile phone. Therefore, the general user who receives this advertising medium can easily obtain the detailed information of the advertisement on a network

As described in Japanese Patent Application Publication No. 2004-30302, the cost of printing can be reduced by addition of an advertisement. However, in the case of applying to photographic printing, when an advertisement is printed with a user's image, the advertisement generally may spoil an otherwise pleasing image that the user has made an effort to produce because regarding the advertisement gives the user an unfavorable impression. In addition, there is the risk that users will stop utilizing the photo printing service altogether.

As described in Japanese Patent Application Publication No. 2002-118680, the detailed information of an advertisement can easily be accessed by using a mobile phone to read a two-dimensional barcode. However, when a two-dimensional barcode for accessing advertisement information is printed on a photographic print in the case of applying to photographic printing, a user may generally find such a two-dimensional barcode to be an annoyance if nothing but the advertisement information was outputted when reading the two-dimensional barcode.

As described above, there is situation inconvenient for the user in the method for adding and printing an advertisement on a photographic print and the method for outputting only advertisement information when reading a two-dimensional barcode. Therefore, such methods cannot be employed, and those methods are disliked by the user even if being employed, so that those methods cannot achieve the purpose of providing a low-price service to the user.

### SUMMARY OF THE INVENTION

The present invention has been contrived in view of such circumstances, and an object thereof is to provide a server and service method whereby a user can utilize a service at low cost through the use of advertisements.

In order to attain the aforementioned object, the present invention is directed to a server comprising: an uploading device which receives an uploading of an image to be printed; a first database which manages additional information related to the image; an access information generating device which generates access information necessary in order for a user terminal to acquire the additional information via a network; a print instruction information creating device which creates instruction information whereby the access information and the image are recorded on a same print medium by a prescribed printer; an access information receiving device which receives the access information inputted to the user terminal according to the print medium from the user terminal; a second database which manages advertisement information; and a downloading device which, when the access information is received from the user terminal, downloads the advertisement information to the user terminal of an access source, the advertisement information being downloaded together with the additional information corresponding to the access information.

According to the present invention, the advertisement information can be presented by this configuration to the user without additional printing of the advertisement information on a printing medium on which an image is printed. Additionally, since the advertisement information is downloaded together with the additional information of the image when access information is inputted to the user terminal, the advertisement information can be presented so as to be easily accepted by the user, thereby enabling a service to be provided to the user at low cost through advertising income.

The present invention is also directed to the server further comprising: a third database which manages service usage charge discount information in association with each of items of the advertisement information; and a billing device which performs billing a service usage charge, wherein: the uploading device receives a selection of the advertisement information to be downloaded to the user terminal of the access source when uploading of the image, the selection being selected from among the advertisement information managed by the second database; and the billing device performs discounting or waiving of the service usage charge according to the discount information corresponding to the selected advertisement information.

According to the present invention, a print-ordering user who uploads an image can select the charge reduction and the different charge (i.e. whether it is free of charge or not), according to the advertisement selected by the user. Furthermore, it is also possible to prevent the user terminal of other people such as a friend from outputting an unknown advertisement without the wishes of the print-ordering user.

The present invention is also directed to the server wherein: the access information receiving device receives personal information of the user of access source received from the user terminal of the access source; and the downloading device selects the advertisement information on basis of the personal information, and downloads the selected advertisement information to the user terminal of the access source.

According to the present invention, since the advertisement information corresponding to personal information of a user distributing the photographic print is downloaded by this above configuration, an owner of the advertisement can reliably advertise to users to whom the owner wishes to advertise. Furthermore, it is also possible to prevent the user distributing the photographic print from receiving an entirely irrelevant advertisement to user.

In addition, it is preferable that the personal information includes at least one of sex, age, and address of the user.

The present invention is also directed to the server further comprising: a third database which manages discount information of a service usage charge in association with each of items of personal information of the user of the access source; and a billing device which performs discounting or waiving of the service usage charge according to the personal information which is received from the user terminal of the access source, and the discount information which is managed by the third database.

According to the present invention, it is possible to perform discounting or waiving of service usage charge in accordance with the effectiveness of advertising.

The present invention is also directed to the server wherein the downloading device selects the advertisement information according to an access location of the user terminal of the access source, and downloads the selected advertisement information to the user terminal of the access source.

According to the present invention, since the advertisement information corresponding to the access location of the user distributing the photographic print is downloaded by this above configuration, the owner of the advertisement can then reliably advertise to users to whom the owner wishes to advertise. Furthermore, it is also possible to prevent the user distributing the photographic print from receiving an entirely irrelevant advertisement to user.

The present invention is also directed to the server further comprising: a third database which manages discount information of a service usage charge in association with map information for indicating an access location in which the user terminal of the access source is located; and a billing device which performs discounting or waiving of the service usage charge, according to the access location and the discount information managed by the third database.

According to the present invention, it is possible to perform discounting or waiving of service usage charge in accordance with the effectiveness of advertising.

The present invention is also directed to the server further comprising a third database which manages personal information of an access source user registered by the user who uploads the image, wherein: when access is received from the user terminal of the access source, the downloading device selects the advertisement information according to the personal information managed by the third database, and downloads the selected advertisement information to the user terminal of the access source.

Preferably, the personal information includes at least one of sex, age, and address of the user.

According to the present invention, because the advertisement information corresponding to the user distributing the photographic print is downloaded by this above configuration, the owner of the advertisement can then reliably advertise to users to whom the owner wishes to advertise. Furthermore, it is also possible to prevent the user distributing the photographic print from receiving an entirely irrelevant advertisement to user.

The present invention is also directed to the server further comprising: a third database which manages personal information of the user registered by the user who uploads the image; a fourth database which manages discount information of a service usage charge in association with each of items of the personal information; and a billing device which performs discounting or waiving of the service usage charge according to information managed by the third and fourth databases when the access information is received from the user terminal of the access source.

According to the present invention, it is possible to perform discounting or waiving of service usage charge in accordance with the effectiveness of advertising.

Preferably, the personal information includes at least one of sex, age, and address of the user.

In order to attain the aforementioned object, the present invention is directed to a server comprising: an input device which inputs image information, sound information, and other contents; a first database which manages the contents inputted by the input device; an access information output designation device which designates an output of access information necessary for a user terminal to acquire the contents via a network; an access information receiving device which receives the access information which is inputted to the user terminal and acquires access related information which includes at least one of personal information relating to a user of an access source and access location information; a second database which manages advertisement information; and a downloading device which downloads the advertisement information to the user terminal of the access source, the advertisement information being downloaded corresponding to the access related information together with the contents corresponding to the access information.

The present invention is also directed to the server further comprising: a third database which manages discount information of a service usage charge in association with respective items of the advertisement information; and a billing device which performs billing of the service usage charge, wherein: the input device which receives a selection of advertisement information to download to the user terminal of the access source, the selection being selected from among the advertisement information managed by the second database; and the billing device which performs discounting or waiving of the service usage charge according to the discount information corresponding to the selected advertisement information.

The present invention is also directed to the server further comprising: a third database which manages discount information of a service usage charge in association with respective items of the access related information; and a billing device which performs discounting or waiving of the service usage charge according to the access related information and the discount information managed by the third database, when accessed from an user terminal of an access source by means of the access information.

In order to attain the aforementioned object, the present invention is directed to a service method comprising the steps of: receiving an upload of an image to be printed; registering additional information relating to the image in a first database; generating access information necessary in order for a user terminal to acquire the additional information via a network; creating instruction information whereby the access information and the image are recorded on a same print medium by a prescribed printer; receiving access information inputted to the user terminal according to the print medium from the user terminal; acquiring advertisement information managed by a prescribed second database; and downloading the advertisement information to the user terminal of the access source, the advertisement information being downloaded together with the additional information corresponding to the access information, when the access information is received from the user terminal.

The present invention is also directed to the service method further comprising a step of performing discounting or waiving of the service usage charge according to discount information managed by a prescribed third database.

In order to attain the aforementioned object, the present invention is directed to a service method, comprising the steps of: registering contents in a prescribed first database; designating an output of access information necessary for a user terminal to acquire the contents via a network; acquiring access related information including at least one of personal information of the user of the access source and access location information while receiving the access information inputted to the user terminal; and downloading advertisement information to the user terminal of the access source, the advertisement information being downloaded corresponding to the access related information together with the contents corresponding to the access information.

In addition, it is preferable that the contents includes at least one of image information, sound information, and text information; and the personal information includes at least one of sex, age, and address of the user.

The present invention is also directed to the service method further comprising a step of discounting or waiving the service usage charge according to discount information managed by a prescribed third database.

As described above, according to the present invention, it is possible for a user to utilize a service at low cost by the use of advertisements.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a general configuration diagram of a service system containing a server according to an embodiment of the present invention;

FIG. 2 is a plan view showing an example of the photographic print according to the embodiment of the present invention;

FIG. 3 is a block diagram showing the specific internal structure of the server according to the embodiment of the present invention;

FIG. 4A is a plan view showing a first sheet of advertisement management information according to the embodiment of the present invention, FIG. 4B is a plan view showing a second sheet of the advertisement management information, and FIG. 4C is a plan view showing a third sheet of the advertisement management information;

FIG. 5 is a schematic block diagram showing the conceptual structure of the server according to first though third embodiments of the present invention;

FIG. 6 is a diagram showing the sequence of service processing according to a first embodiment of the present invention;

FIG. 7 is a diagram showing the sequence of service processing according to a second embodiment of the present invention;

FIG. 8 is a diagram showing the sequence of service processing according to a third embodiment of the present invention;

FIG. 9 is a schematic block diagram showing the conceptual structure of the server according to a fourth embodiment of the present invention; and

FIG. 10 is a diagram showing the sequence of service processing according to a fourth embodiment of the present invention.

### DETAILED DESCRIPTION OF THE PREFERRED EMBODIMENTS

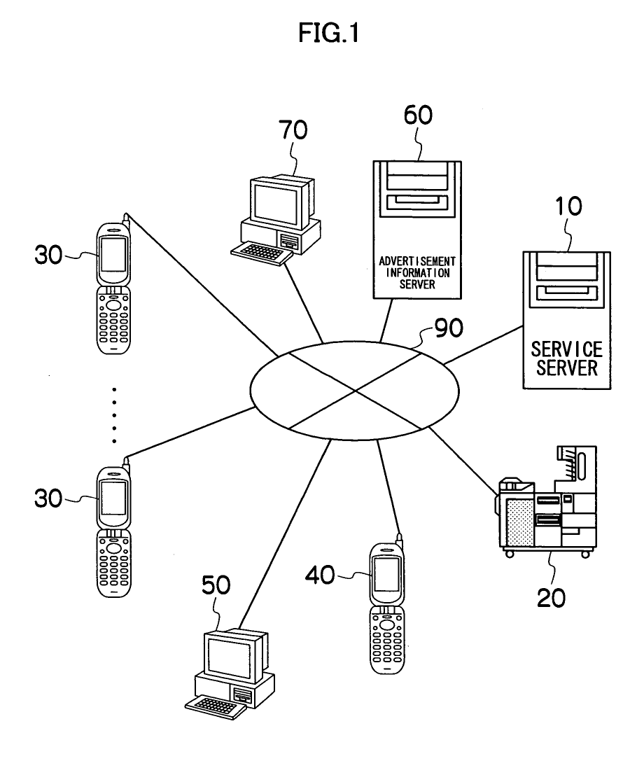

FIG. 1 is a general configuration diagram of a service system containing a service server 10 according to an embodiment of the present invention. In FIG. 1, the service system comprises: the service server 10; a printer 20; a plurality of users' camera-equipped mobile phones (hereinafter referred to simply as “mobile phones”) 30 and 40; a user's personal computer (hereinafter referred to simply as “PC”) 50; an advertisement information server 60; and an advertiser terminal device 70, and is composed by connecting each other via a network 90.

The service server 10 communicates with the printer 20, the mobile phones 30 and 40, the PC 50, and the advertisement information server 60 via the network 90, and performs: a printing service which forms a photographic print according to a user order; a registration service which stores registration information (as additional information) relating to the image to be printed for a prescribed period of time; an advertisement service which transmits the advertisement information together with the registration information via the network 90; and various other services.

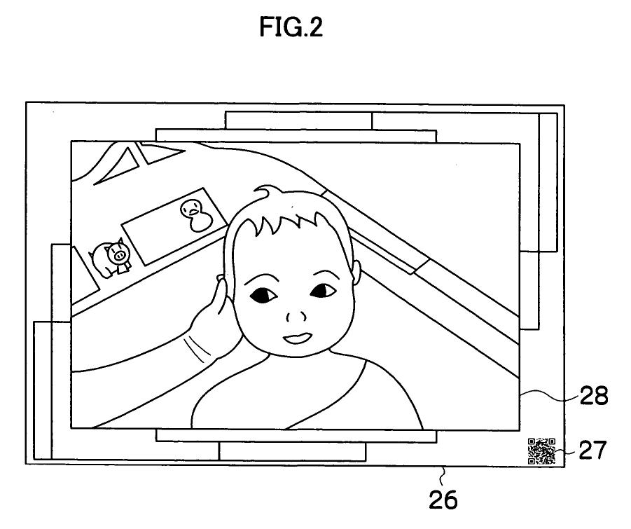

The printer 20 forms a photographic print 26 as shown in FIG. 2 according to the control of the service server 10. The printer 20 prints a two-dimensional barcode 27 such as a QR code (registered trademark) on the photographic print 26 along with the image 28 for which printing is ordered.

The mobile phones 30 and 40 have a capability to photograph a subject. In addition, the mobile phones 30 and 40 have a capability to photograph and decode a two-dimensional barcode, and to access the service server 10 via the network 90 according to the decoded results. Though FIG. 1 shows only the first mobile phones 30, the second mobile phone 40, and the PC 50, there are several user terminals connected via the network 90 actually.

For convenience in description hereinafter, the mobile phones 40 and the PC 50 are uploading-user terminals in the possession of the user ordering a print, which being used for uploading an image or registration information to the service server 10; and the mobile phone 30 is a downloading-user terminal in the possession of a user distributing the photographic print, which being used for receiving advertisement information and registration information which is downloaded from the service server 10. The above arrangement is adopted for convenience in the description hereinafter, but it is actually possible for the mobile phone 40 of the user ordering a print to download the advertisement information and registration information from the service server 10 when the user ordering a print is in possession of the photographic print.

The advertisement information server 60 provides advertisement information to the service server 10.

The advertiser uses the advertiser terminal device 70 to register the advertisement information in the advertisement information server 60.

Specifically, the advertisement information server 60 has a database (not shown) which forms a storage device for storing various types of advertisement information, and advertisement information inputted to the terminal device 70 of the advertiser is registered in the database of the advertisement information server 60. The advertisement information registered in the database of the advertisement information server 60 is sent to the service server 10 via the network 90.

Furthermore, the advertiser terminal device 70 is used to input the advertisement setting information which indicates the type of user to whom the advertisement is to be presented (i.e. the advertisement setting information as a part of the advertisement management information for managing the advertisement information). This advertisement setting information is transmitted from the advertiser terminal device 70 to the service server 10 via the advertisement information server 60, and is registered in the database of the service server 10 as a part of the advertisement management information. The advertiser can input and set items such as the sex, location, or age of the advertising target, and the advertising time period, as advertising setting information, to the terminal device 70. In addition, the advertiser can input and set a charge point corresponding to number of downloading the advertisement information (one type of discount information).

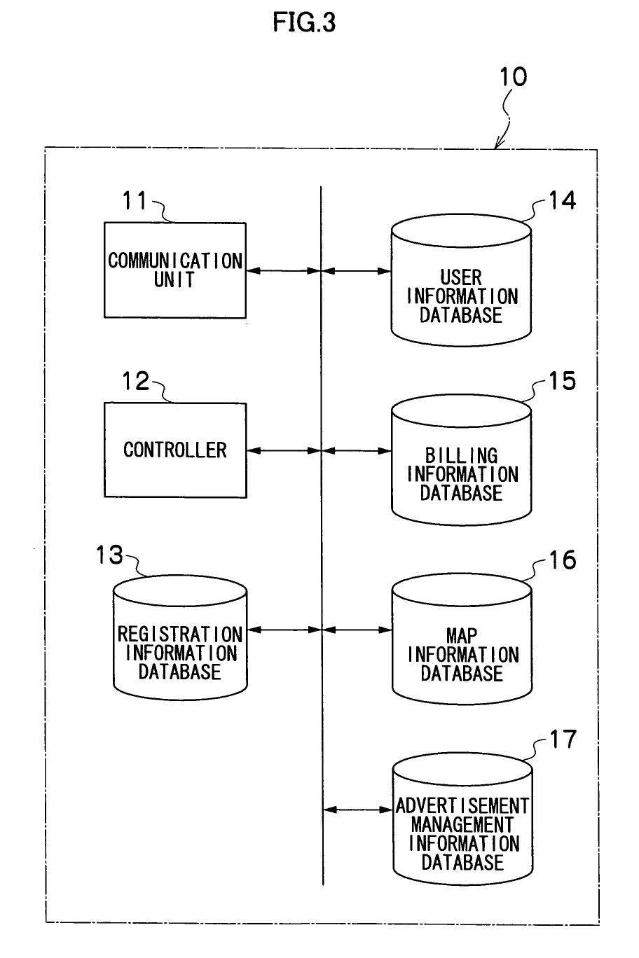

FIG. 3 is a block diagram showing the specific internal structure of the service server 10 according to the embodiment of the present invention. As shown in FIG. 3, the service server 10 mainly comprises: a communication unit 11 which communicates with the printer 20, the first and second mobile phones 30 and 40, and the PC 50 via the network 90; a controller 12 composed of a CPU (Central Processing Unit); a registration information database 13; a user information database 14; a billing information database 15; a map information database 16; and an advertisement management information database 17. Moreover, it is not necessary to build the databases 13 through 17 into the case of the service server 10, and an embodiment also may be adopted whereby the databases 13 through 17 are built apart from the service server 10 and connected to the service server 10 via the network 90 shown in FIG. 1.

The communication unit 11 communicates with each devices connected to the network 90. The communication unit 11 is capable of communicating with the mobile phones 30 and 40 and the PC 50 by HTTP (Hypertext Transfer Protocol).

The registration information database 13 manages sound information, text information, moving image information, still image information, multimedia contents, and other registration information to be downloaded to the mobile phone 30. In this case, the registration information is information in association with the image to be printed. The printed image itself is also included therein. There is a case in which items of the registration information are uploaded together with the image to the service server 10 from the mobile phone 40 and the PC 50 used by the user ordering the print, while being registered at the time of the print order. In addition, there is also a case in which the registration information is downloaded to the service server 10 from the mobile phone 40 and the PC 50 used by the user ordering the print, while being registered after the print order.

The user information database 14 stores user information related to the user ordering the print or the user to whom the photographic print is distributed. For example, a sex, an address, and an age of the user are included in the user information.

The billing information database 15 manages information related to charges for the user ordering the print or the advertiser. Specifically, the billing information database 15 is configured so as to store discount information related to the service charge for each advertising subject.

Herein, in the case of advertising the actual advertiser such as a coffee shop, a pub, or a financial institution, for example, the advertisement subject is the advertiser. In addition, in the case of advertising a product or service relating to the advertiser, the advertisement subject is the related product or service. There may be other advertisement subjects, apart from those.

For example, the billing information database 15 manages information which indicates that the advertisement of a specified coffee shop such as the advertising subject implements a 20% discount, information which indicates that the advertisement of a specified pub implements a 50% discount, and information which indicates that the advertisement of a specified financial business makes the service free of charge (100% discount). More specifically, it is preferable to store in the form of table information that associates an advertiser ID identifying an advertiser with a discounting rate. It is also possible to store in the form of table information that associates an advertisement ID identifying advertisement information with a discounting rate. Hereafter, a “free of charge” service (a service waiving charge) may also be referred to as a “discount”.

In addition, the billing information database 15 manages a plurality of charge points (as a type of the discount information) corresponding to the number of downloading the advertisement information, for example. More specifically, it is preferable to store table information that associates an advertiser ID identifying an advertiser with a charge point. It is also possible to store table information that associates an advertisement ID identifying advertisement information with a charge point.

Furthermore, the billing information database 15 can manage the discount information in association with each item (such as age, sex, and address) of user information, for example. The billing information database 15 can also manage the different discount rate according to each age groups, for example 10 to 20, 20 to 30, 30 to 40, and 40 and over, to a specified product as the advertising subject. More specifically, it is preferable to store a table information that specifies different discounting rates for different age groups such as 10 to 20, 20, to 30, 30 to 40, and 40 and over, for example. It is also possible to store table information that indicates different discounting rates for more specific age groups (such as 10 to 14, 15 to 19, 20 to 24, 25 to 29, and the like).

The billing information database 15 can also manage the different discount rates according to sex to the specified product that is the subject of advertisement, for example. More specifically, it is preferable to store table information that specifies different discounting rates for males and females.

Further, the billing information database 15 can also manage different discount rates according to each the geographic environments, for example. More specifically, it is preferable to store table information that specifies different discounting rates for different geographic regions.

The map information database 16 manages map information.

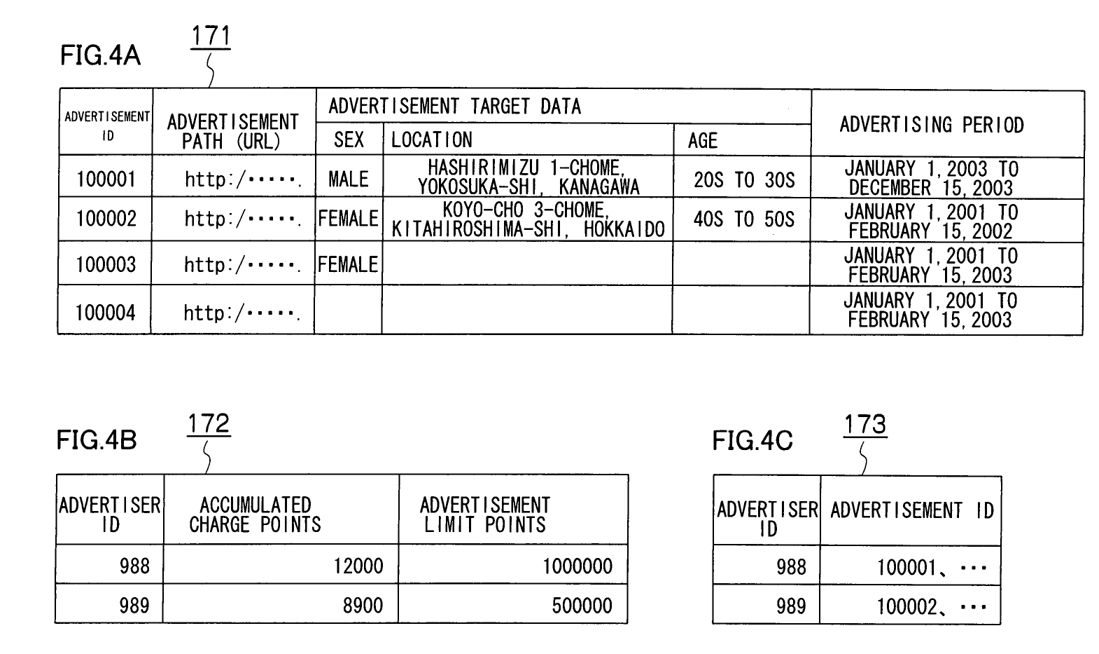

The advertisement managing information database 17 manages advertising management information. FIGS. 4A, 4B, and 4C show an example of advertising management information. In the first table 171 shown in FIG. 4A, the advertisement managing information database 17 registers the advertisement ID, the advertising path needed in order to acquire the advertisement information from the advertisement information server 60, the advertising target items (such as sex, location, and age), and the advertising period, corresponding to each the advertising subjects. In the second table 172 shown in FIG. 4B, the advertisement managing information database 17 registers the advertiser ID, accumulated charge points, and point limit of the advertisement, corresponding to each the advertisers. The third table 173 shown in FIG. 4C shows the correlation between the advertiser ID and the advertisement ID.

In this way, the advertisement management information database 17 manages the method of acquiring advertisement information, the advertisement target, the advertising time period, and other advertisement management information, associated with each of advertisement information.

Incidentally, when the advertisement information is to be presented to an unspecified user, the data indicating “not specified” (for example, blank data) is set for the respective items (such as sex, location, and age) of the “advertisement target”.

For example, as shown in FIG. 4A, in a row where the “advertisement ID” is “100001” and a row where the “advertisement ID” is “100002”, each of the data specifying an advertisement target has been set for all of the items “sex”, “location”, and “age” of the “advertisement target”. On the other hand, in a row where the “advertisement ID” is “100003”, the data specifying an advertisement target has been set for “sex” (in this case, as the data specifying the advertisement target to be female users), but the blank data indicating an unspecified state has been set for “location” and “age”. Furthermore, if a row where has an “advertisement ID” of “100004”, blank data indicating an unspecified state has been set for all of the items, “sex”, “location” and “age”.

The advertiser ID, accumulated charge points, and point limit of the advertisement are registered for each advertiser in the second table 172 shown in FIG. 4B.

The third table 173 shown in FIG. 4C shows the correlation between the advertiser ID and advertisement ID.

As described above, the advertisement management information database 17 manages various types of advertisement information by managing the advertisement management information.

In addition, the advertisement management information database 17 manages the advertisement designation information (including information indicating the presence or absence of an advertisement, and information indicating the selected advertisement) designated by the user ordering the print. More specifically, the advertisement management information database 17 stores table information that associates: identification information id which identifies a printed image while identifying registered information; information indicating the presence or absence of an advertisement; and an advertisement ID which identifies advertisement information (or an advertiser ID identifying an advertiser) if an advertisement is indicated to be present.

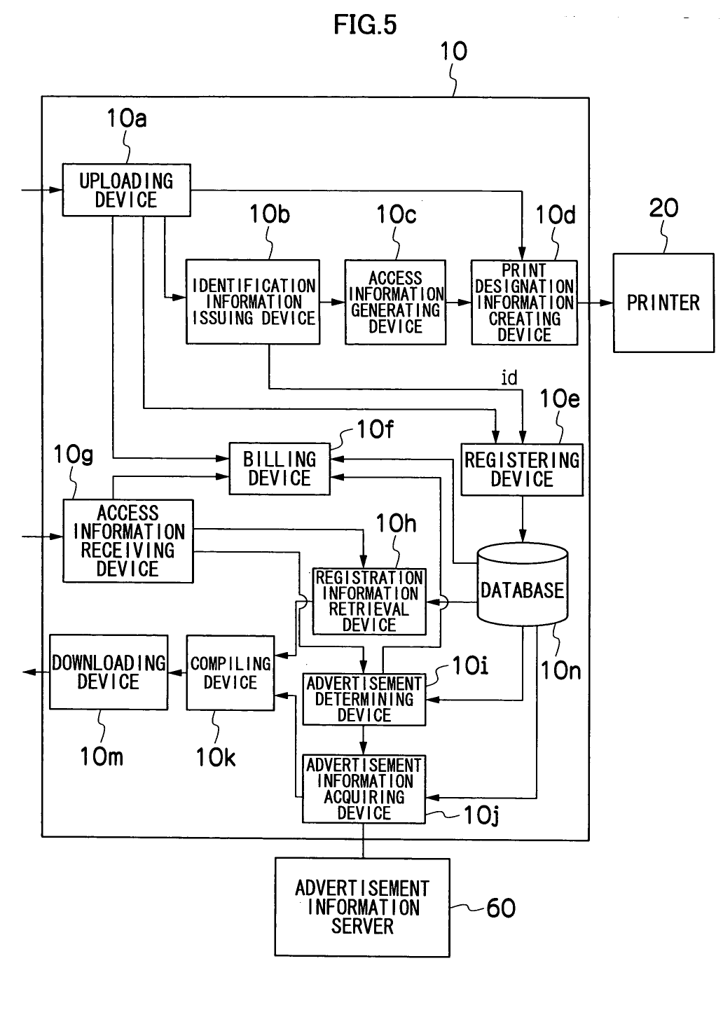

FIG. 5 is a schematic block diagram showing the conceptual structure of the service server 10 according to the first through third embodiments of the present invention. As shown in FIG. 5, the service server 10 comprises: an uploading device 10a; an identification information issuing device 10b; an access information generating device 10c; a print designation information creating device 10d; a registering device 10e; a billing device 10f; an access information receiving device 10g; a registration information retrieval device 10h; an advertisement determining device 10i; an advertisement information acquiring device 10j; a compiling device 10k; a downloading device 10m; and a database 10n.

The uploading device 10a receives via the network 90 an upload of order information from the mobile phone 40 and PC 50 used for the user ordering the print.

The uploaded order information includes the printed image, the downloaded registration information (such as sound information, moving image information, text information, and other additional information), delivery information indicating the method of delivering the formed photographic print, advertisement designation information (including information indicating the presence of an advertisement, and information indicating the selected advertisement) specified by the user ordering the print, and user information (such as age, sex, address, and other information).

The identification information issuing device 10b issues the identification information id which identifies the image to be printed and the registration information. The identification information issuing device 10b has a case in which the identification information id corresponds in one-to-one fashion with the image to be printed, and a case in which one set of identification information id corresponds to a plurality of images to be printed that are grouped together in the same print order.

The access information generating device 10c generates access information needed to acquire the registration information via the network 90 by the mobile phone 30 of user to whom the photographic print is distributed. The access information includes a URL (Uniform Resource Locator) and identification information id. The URL includes the communication protocol identification information (http) and the domain name of the service server 10.

The print designation information creating device 10d creates instruction information which provides the printer 20 to record the access information and the printed image on the same printing medium. According to the above instruction information, the printer 20 forms a photographic print 26 as shown in FIG. 2. Further, the embodiment in which the access information is recorded is not particularly limited to a two-dimensional barcode, but an embodiment in which a two-dimensional barcode is printed in the vicinity of the image is described hereinafter for the sake of convenience.

The registering device 10e registers the registration information, the delivery information, the advertisement designation information, and the user information in the database 10n, in association with the identification information id.

The billing device 10f performs billing of the service usage charge. Specifically, the discount information corresponding to the downloaded advertisement information is retrieved from the database 10n, and the usage charge for the service is discounted or waived according to the discount information.

Incidentally, with regard to processing for collecting the service usage charge after discounting a service usage charge has been applied by the billing device 10f, a commonly well-known technique should be used to collect the service usage charge, such as charging the mobile phone operator, making payment by credit card, making payment by electronic money, or the like. Detailed description of the collection method is omitted here.

The access information receiving device 10g receives the access information 27 inputted to the mobile phone 30 of user distributing the photographic print 26 from the corresponding mobile phone 30. The access information thus received contains a URL and the identification information id. Furthermore, inputting of the access information is not limited to the reading of the two-dimensional barcode in particular. The present invention also includes an inputting embodiment by operating panel of the mobile phone 30, for example. However, an embodiment in which a two-dimensional barcode is read by the mobile phone 30 is described hereinafter for the sake of convenience.

The registration information retrieval device 10h retrieves the registration information associated with the identification information id received from the mobile phone 30 of access source from the database 10n.

The advertisement determining device 10i determines what advertisement information should be downloaded to the access source mobile phone 30.

As specific embodiments of the advertising information to be downloaded, in a first embodiment, selection of the advertisement information is received when uploading the image, and then advertisement designation information indicating the advertisement information selected is associated with the identification information id and stored in advance in the database 10n. When access occurs in which the access information (two-dimensional barcode) of the photographic print is used, the advertisement designation information is retrieved from the database 10n according to the identification information id in the access information, and the advertisement information to be downloaded is determined according to the above advertisement designation information.

In a second embodiment, when accessed by means of the access information on the photographic print, the user information (such as sex, age, and other information) of access source is received from the mobile phone 30 of access source, and then the advertisement information to be downloaded is determined according to the user information, the access location, and the advertisement management information (indicating the sex, location, and age of the user to whom the advertisement information will be presented), in the database 10n.

In a third embodiment, the information (such as sex, address, and age) of the user to whom the photographic print is distributed, which has been inputted by the print-ordering user who uploaded the image, is associated with the identification information id and stored in advance in the database 10n. When accessed via the access information on the photographic print, the user information of access source is specified according to the identification information id in the access information, and then the advertisement information to be downloaded is determined according to the user information and the advertisement management information (indicating the sex, location, and age of the user to whom the advertisement information will be presented), in the database 10n.

In a fourth embodiment, optimal advertisement information to be downloaded to the mobile phone 30 of access source is determined from among the advertisement information registered in the advertisement information server 60, according to the image to be printed or the additional information. More specifically, the user as access source is inferred from the image to be printed or the additional information, and the advertisement information to be downloaded is determined according to the inference result of the user as access source, and on the advertisement management information (indicating the sex, location, and age of the advertisement target) stored in the database 10n.

As specific modes of inferring the user as access source (inference mode of an access user), there is a first mode of inferring the sex and age of the principal subject of the image according to the image to be printed, by using commonly well-known image recognition technology. In addition, there is a second mode of inferring the sex and age of the principal subject of the image according to the sound information by using commonly well-known voice recognition technology if sound information is added to the image to be printed, as additional information. For example, the sex (male or female) and age of principal subject in the image is determined according to whether the voice is high or low. Furthermore, it is also possible to infer the sex and age of principal subject in the image by combining the first and second access user inference modes described above.

Incidentally, the timing of inferring the user of access source is not limited to real-time inference when the service server 10 has been accessed by the user's mobile phone 30 of access source, and the inference process may also be carried out previously, before accessing from the mobile phone 30 of user as access source. For example, when the image to be printed and the additional information have been uploaded, it is preferable to infer the user as access source forming the download destination previously.

The advertisement information acquiring device 10j acquires the advertisement setting information (such as sex, location, and age of advertisement target, advertising period, charge points per download, and the other information), as a part of advertisement management information inputted in the advertiser terminal device 70, from the advertisement information server 60.

In addition, the advertisement information acquiring device 10j also acquires the advertisement information from the advertisement information server 60. In the case in which the advertisement information is registered in the database 10n of the service server 10, the advertisement information acquiring device 10j acquires the advertisement information from the database 10n.

Incidentally, the timing at which the advertisement information acquiring device 10j acquires the advertisement information is not limited to the case that advertisement information is acquired from the advertisement information server 60 when the service server 10 is accessed by the mobile phone 30 of user as access source. For example, it is also possible to acquire advertisement information previously from the advertisement information server 60 and to store the information in the database 10n of the service server 10 (for example, the advertisement management information database 17 shown in FIG. 3). Then, the advertisement information can be acquired from the database 10n of the service server 10 when the service server 10 is subsequently accessed by the mobile phone 30 of user as access source.

The compiling device 10k combines the advertisement information with the registration information and compiles the data to be downloaded to the access source mobile phone 30.

The downloading device 10m downloads the registration information corresponding to the received access information along with the advertisement information to the mobile phone 30 of access source when the access information receiving device 10g has received the access information from the mobile phone 30.

The database 10n manages by associating the registration information, the delivery information, the advertisement designation information, and the user information with the image identification information id. In addition, the database also manages the advertisement management information that is based on the advertisement setting information inputted in the advertiser terminal device 70.

As briefly described the relationship between the constituent elements of the service server 10 shown in FIG. 5 and the specific structure of the service server 10 shown in FIG. 3, the uploading device 10a, the access information receiving device 10g, the advertisement information acquiring device 10j, and the downloading device 10m shown in FIG. 5 are comprised of the communication unit 11 and controller 12 shown in FIG. 3; the identification information issuing device 10b, the access information generating device 10c, the print designation information creating device 10d, the registering device 10e, the registration information retrieval device 10h, the advertisement determining device 10i, and the compiling device 10k shown in FIG. 5 are comprised of the controller 12 shown in FIG. 3; and the database 10n shown in FIG. 5 is comprised of the registration information database 13, the user information database 14, the billing information database 15, the map information database 16, and the advertisement management information database 17 shown in FIG. 3.

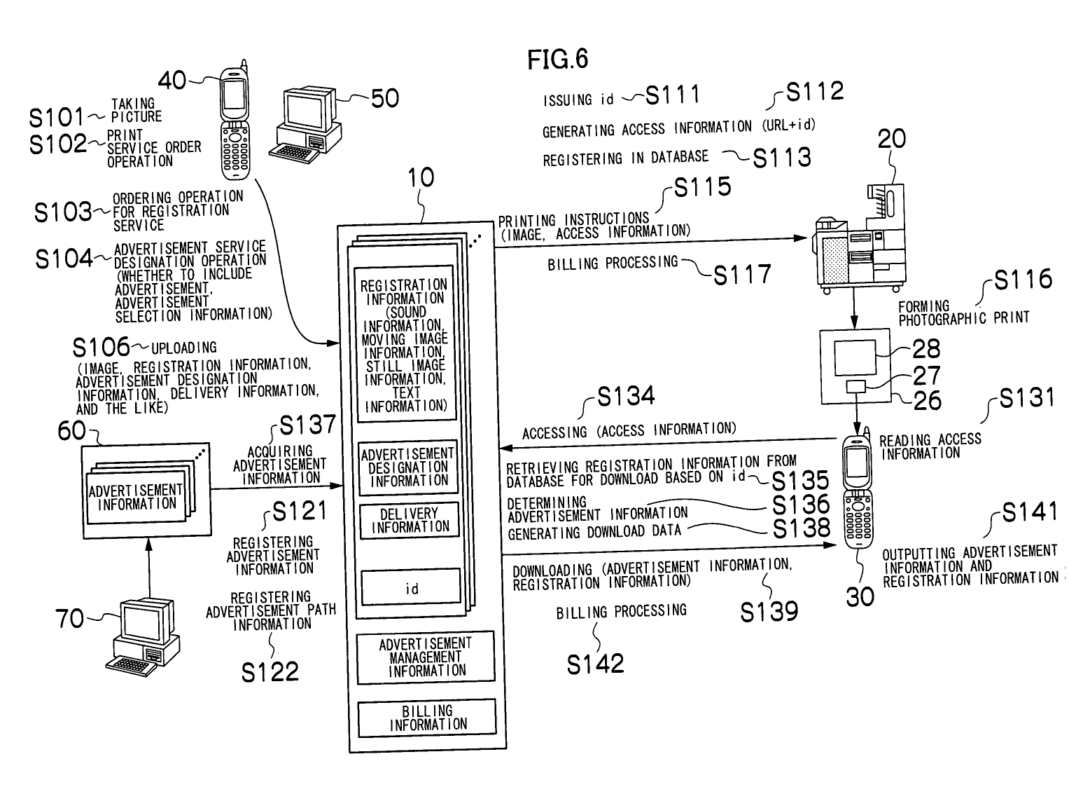

Next, the sequence of service processing according to a first embodiment is described with reference to FIG. 6.

First, as shown in FIG. 6, the user ordering a print photographs a subject using the mobile phone 40 (S101). When a still image is acquired by this picture taking, it is possible to add the sound information inputted using the mobile phone 40 after shooting to the still image to be printed. In addition, it is possible to add the text information inputted using the mobile phone 40 after shooting to the still image to be printed. When a moving image is acquired, it is possible to extract a still image to be printed from the moving image. In addition, it is possible to add the sound information recorded simultaneously with shooting of the moving image to a still image to be printed. Furthermore, it is also possible to add text information inputted using the mobile phone 40 after shooting to a still image to be printed.

Next, the user ordering the print performs the ordering operation of the print service using the mobile phone 40 (S102). In this case, the above print service is a service for forming a photographic print in which the image is printed on a prescribed printing medium. Specifically, the print service selects an image to be printed from among a plurality of still images obtained by photographing, and inputs the size, number, or the like of the photographic print as necessary. In addition, it is possible to extract a still image for printing from a moving image. The delivery method for the photographic print is also specified. For example, when the user ordering the print goes directly to a photo shop or other specified pickup location for pickup, the pickup location is specified. In addition, when a delivery destination is specified and a delivery by mail, parcel service, or the like is requested, for example, the delivery destination is specified. In this case, the photograph is packaged and sent to the desired destination for delivery. In the case of a postcard, it is also possible to request the delivery of the postcard itself to the desired destination.

In addition, the user ordering the print performs the ordering operation of the registration service using the mobile phone 40 (S103). In this case, the registration service is a service in which the service server 10 registers digital contents (such as sound information, text information, moving image information, and other registration information) relating to an uploaded image or a corresponding image in the registration information database 13. For example, when a still image obtained by photographing is to be printed, it is possible to request that the still image and the sound information and text information added to the still image be registered. When a still image extracted from a moving image is to be printed, it is possible to request that the still image, the moving image from which the still image was extracted, the sound information recorded simultaneously with shooting of the moving image, and the text information inputted after shooting be registered as the registration information. Such the registration information is downloaded by the mobile phone 30 of user to whom the photographic print is distributed, as described hereinafter. Besides a configuration in which the registration information is uploaded to the service server 10 and registered, a configuration may also be adopted in which the desired template information is selected from among a plurality of template information items registered in advance in the service server 10, and only information for linking to the selected template is registered. For example, a configuration may be adopted in which multimedia contents created in advance in Flash (trademark) and the like is selected, and in which the information for linking to the selected multimedia contents is registered.

Moreover, the user ordering the print performs the designation operation of the advertisement service using the mobile phone 40 (S104). In this case, the advertisement service is a service in which the usage charge for the registration service for which the user ordering the print is billed is discounted or waived (the charge is cancelled) by downloading the prescribed advertisement information along with the registration information when downloading the registration information stored in the registration information database 13 to the mobile phone 30 at the delivery destination of the photographic print. Generally, the discounted portion of the charge is billed to the advertiser. Specifically, by operating the mobile phone 40, the user ordering the print selects whether to add an advertisement or not. Then, the user selects the advertised subject when making a selection of adding an advertisement.

More specifically, designated screen information of the advertisement service is transmitted from the service server 10 to the mobile phone 40, first. Then, since a list of selectable advertised subjects is displayed on the screen of the mobile phone 40, the user ordering the print performs the operation of setting the user's intention to utilize the advertisement service while performing the operation of selecting an advertised subject with the mobile phone 40. For example, the names or logos of coffee shops, pubs, theme parks, movies, financial businesses, and other advertised subjects are displayed on the screen of the mobile phone 40, and a discount rate (20%, 50%, 100% and the like; also referred to as a reduction rate) is displayed for each advertised subject. In this screen, when the user ordering the print uses the advertisement service, the user selects the advertised subject and specifies that an advertisement will be included. The embodiment is not limited to the case in which the name or logo of the advertised subject is selected in this manner. The desired advertisement information may also be selected after the advertisement information (such as sound information, text information, moving image information, still image information, multimedia contents, and the like) itself is actually played back by the mobile phone 40.

When the user ordering the print selects the advertised subject, there is a case that assigns the highest priority to obtaining the largest discount, while there is also a situation that assigns the highest priority to selecting the advertised subject. Specifically, for example, while other users may select the pub's advertisement over that of the coffee shop, some users may select the advertisement for a pub over that of a coffee shop, in consideration of the print-ordering user's own age or sex, the age and sex of a friend distributing the photographic print, the personal relationship between the two users, and other factors. Further, other users may select whichever advertisement offers the highest discount (for example, one that allows free service) regardless of the advertised subject. Therefore, the print service user can select his or her desired advertisement information.

Of course, the present invention is not limited to discounting the usage charge for the registration service, and it is also possible to adopt reducing the usage charge for the print service jointly.

Then, when the user ordering the print performs the prescribed transmission operation using the mobile phone 40, the order information is uploaded via the network 90 from the mobile phone 40 to the service server 10 (S106). Herein, the order information contains the image to be printed, the registration information (such as sound information, text information, moving image information, and the like), the advertisement designation information, and the photographic print delivery information. At this time, the advertisement designation information includes information indicating presence or absence of the advertisement, the advertised subject, and selection information indicating the advertisement information to be selected if an advertisement is indicated to be present. The selection information includes an advertisement ID identifying advertisement information.

In the case that uploads the registration information, the advertisement designation information, and the delivery information, it is also possible to be performed after the image to be printed is downloaded, instead of being performed simultaneously with the uploading of the printing image.

Furthermore, an example of a case in which the uploading is performed from the mobile phone 40 to the service server 10 is described above, but a composition may be also adopted in which an image is taken by a digital camera not shown in FIG. 6 (S101), the storage media which stores the photographic image is mounted in the PC 50, and ordering of the print service (S102), ordering of the registration service (S103), designating of the advertising service (S104), and uploading of the order information to the service server 10 (S106) are performed by the PC 50.

Next, the service server 10 having received the upload of the order information issues identification information id for each the images to be printed (S111). The identification information id is used for identifying the registration information downloaded to the mobile phone 30 of user to whom the photographic print is distributed while using for identifying the image to be printed.

Then, the service server 10 generates the access information necessary for the mobile phone 30 of user to whom the photographic print is distributed to acquire the registration information from the service server 10 via the network 90 (S112). The access information in this arrangement contains a URL (Uniform Resource Locator) and the identification information id.

In addition, the service server 10 registers the information uploaded from the mobile phone 40 or PC 50 in a database (S113). Specifically, the registration information, the advertisement designation information, the delivery information, and other uploaded information are registered to the database in association with the identification information id.

The image and the access information are transmitted from the service server 10 to the printer 20 (S115), and a photographic print 26 is formed by the printer 20 (S116). In this case, the access information is printed together with the printed image 28 onto the same printing medium, as a two-dimensional barcode 27.

In addition, the service server 10 performs billing (S117). For example, the entire amount of the usage charge for the print service is billed to the user who ordered the print. As for the usage charge for the registration service, according to the advertisement designation information received from the mobile phone 40, the discounted portion thereof is billed to the advertiser, and the remaining portion thereof is billed to the user who ordered the print. When the advertiser pays the entire balance for the registration service, the user who ordered the print pays only the usage charge for the print service. When the advertiser also pays the discounted portion of the print service usage charge, the user who ordered the print also pays only the remaining portion after discount for the print service.

In this manner, while the order information is uploaded to the service server 10, the advertisement information is uploaded from the advertiser terminal device 70 to the advertisement information server 60, and is registered in the database of the advertisement information server 60 (S121). An advertisement path needed in order for the service server 10 to acquire the advertisement information on the advertisement information server 60 via the network 90 is then registered in the database of the service server 10 (S122).

Next, according to the first embodiment, the sequence of processing in which the service server 10 downloads the advertisement information and the registration information to the mobile phone 30 of the destination distributing the photographic print 26 will be described below.

The user to whom the photographic print 26 is distributed sets the user's mobile phone 30 to a mode for reading a two-dimensional barcode, and uses the mobile phone 30 to read the two-dimensional barcode 27 on the photographic print 26 (S131). Then, the access information is transmitted from the mobile phone 30 to the service server 10, and this access information is received by the service server 10 (S134). The access information thus received contains the identification information id.

The service server 10 having received the access information extracts the identification information id contained in the access information and retrieves the registration information and advertisement designation information relating to the identification information id from the database (S135).

Next, the service server 10 determines the advertisement information necessary to download according to the advertisement designation information (S136), requests the advertisement information from the advertisement information server 60 according to the advertisement path, and acquires the requested advertisement information from the advertisement information server 60 (S137).

Then, the service server 10 generates download data by merging the advertisement information acquired from the advertisement information server 60 with the registration information retrieved from its own database (S138), and performs a download to the mobile phone 30 of access source (S139).

The mobile phone 30 outputs the downloaded advertisement information and registration information (S141). When anything of the advertisement information and registration information is composed of a sound, the sound of the advertisement information (for example, “Brought to you by XXXX Coffee.”) is outputted, and then is followed by outputting the sound of the registration information (for example, a sound recorded by the user ordering the print). When the advertisement information is composed of the multimedia contents while the registration information is a moving image with sound, the playback (for example, a specified animated character presents the advertisement with images and sound) of the multimedia contents which constitutes the advertisement information is followed by the playback of the moving image with sound that constitutes the registration information. In addition, it is possible for the advertisement information and the registration information to be played back simultaneously. For example, a composition may be adopted in which the multimedia contents constituting the advertisement information is played back and a specified animated character moves on the screen of the mobile phone 30 while the sound constituting the registration information is outputted by the mobile phone.

Incidentally, if “no advertisement” has been specified in the advertisement designation information, only the registered information is downloaded to the access source mobile phone 30, and then only the registered information is output on the mobile phone 30.

Furthermore, the service server 10 performs billing (S142). In this billing process, the number of accessing from the mobile phone 30 is counted for each identification information id, for example, and when the number of access exceeds a prescribed threshold value, processing for further discounting the registration service charge is performed. Alternatively, processing may be performed for giving points equivalent to a cash balance to the corresponding user who orders a print according to the number of accessing.

A composition may be adopted whereby only billing for the print service usage charge is performed in the billing processing performed for an upload from the mobile phone 40 or the PC 50 (S117), and only billing for the registration service usage charge is performed in the billing processing performed for a download to the mobile phone 30 (S142).

Furthermore, a composition may be adopted in which the time, the image quality, the number of accessing, the access times, the accessed users, and other information for a moving image are registered when the registration information is uploaded, and billing processing is performed according to the information thus registered.

The present invention does not prohibit downloading only the registration information; specifically, ignoring the advertisement information. If the user ordering the print specifies that an advertisement is not to be included when the registration information is uploaded, only the registration information is downloaded to the mobile phone 30 of access source. In this case, reduction of the registration service usage charge as a rule is not performed.

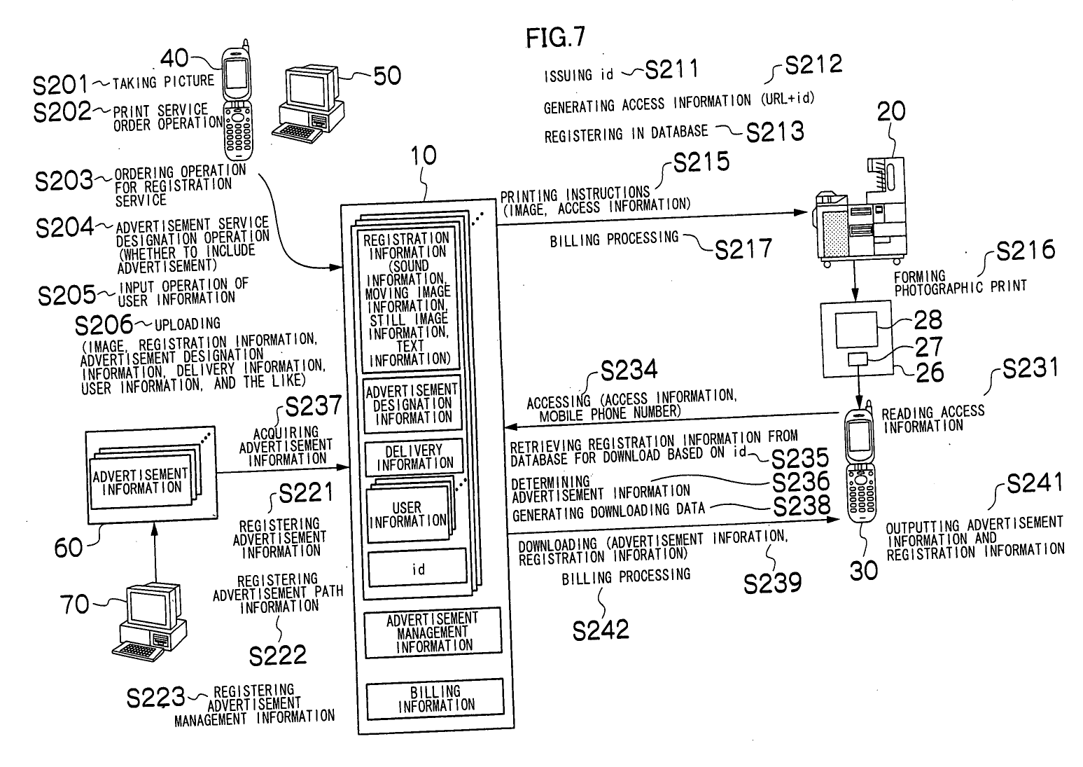

Next, the sequence of service processing according to a second embodiment will be described by using the flowchart in FIG. 7.

In FIG. 7, the user ordering the print photographs an object using the mobile phone 40 (S201), performs the ordering operation for the print service (S202), and performs the ordering operation for the registration service (S203), as similar to the first embodiment.

According to the second embodiment, the user ordering the print performs the operation for designating an advertisement (S204), and then performs the operation for inputting the user information of the user to whom the photographic print is distributed (S205).

The user information contains the sexes, addresses, ages, and mobile phone numbers of each the users. Inputting a specific value of the age is not necessary, and it is also possible to inputted age specifications of “teens,” “twenties,” “thirties,” “forties,” “fifties,” or the like.

In the case in which inputting an age is not required for each destination to which the photographic print will be distributed, for example, an input of “twenties” may only be entered once when most of the destination users are in their 20s. Also, in the case in which inputting a sex is not required for each photographic print destination, for example, an input of “female” may only be entered once when the majority of the destination users are female. Furthermore, it is also possible to exclude age from the inputted information.

Then, when the user ordering the print performs a prescribed transmission operation using the mobile phone 40, the order information is uploaded from the mobile phone 40 to the service server 10 via the network 90 (S206).

Herein, the order information includes image to be printed, the registration information (such as sound information, text information, moving image information, and the like), the advertisement designation information, the photographic print delivery information, and the user information of the photographic print destination (such as mobile phone number, age, and sex). At this time, the advertisement designation information includes information indicating the presence or absence of an advertisement.

Though an example of uploading from the mobile phone 40 to the service server 10 is described above, a composition may also be adopted in which an image is taken by a digital camera not shown in FIG. 7 (S201), and order information is uploaded from the PC 50 by performing a prescribed operation using to the PC 50 (S202, S203, S204, S205, and S206).

The service server 10 which has received the upload of the order information issues the identification information id for each the images to be printed (S211), generates the access information (S212), and registers the uploaded information in a database (S213).

According to the second embodiment, the user information that has received from the mobile phone 40 of the user ordering the print is registered in the database of the service server 10. When sexes, addresses, ages, and mobile phone numbers of each the users which has distributed a photographic print are inputted, those items of user information including the sex, address, age, and mobile phone number are managed in association with identification information id.

The image and the access information are also transmitted from the service server 10 to the printer 20 (S215), and the photographic print 26 is formed by the printer 20 (S216). In this case, the access information is in a two-dimensional barcode 27 that is printed together with the printed image 28 on the same printing medium.

In addition, the service server 10 performs billing of the print service usage charge (S217).

While the order information is uploaded to the service server 10 in this manner, the advertisement information is uploaded from the advertiser terminal device 70 to the advertisement information server 60, and is registered in the database (not shown) of the advertisement information server 60 (S221).

Additionally, an advertisement path necessary for the service server 10 to acquire the advertisement information on the advertisement information server 60 via the network 90 is registered in the database of the service server 10, as a part of the advertisement management information (S222).

Furthermore, when advertisement setting information, such as the advertisement target, the advertising time period, the advertisement points limit, and the like, are inputted from the advertiser terminal device 70, the advertisement setting information is transferred to the service server 10 via the advertisement information server 60, and then is registered in the database of the service server 10 as a part of the advertisement management information (S223).

Next, according to the second embodiment, the sequence of processing to download the advertisement information and the registration information from the service server 10 to the mobile phone 30 of the destination that distributes the photographic print 26 will be described below.

First, when the two-dimensional barcode 27 on the photographic print 26 is read by the mobile phone 30 of user to whom the photographic print 26 will be distributed (S231), the mobile phone 30 transmits the access information and the mobile phone number of the mobile phone 30 to the service server 10, and then the service server 10 receives the transmitted access information and the mobile phone number (S234). The access information contains the identification information id.

The service server 10 having received the access information and the mobile phone number extracts the identification information id contained in the access information, and retrieves the registration information associated with the extracted identification information id from the database (S235).

Next, the service server 10 verifies the mobile phone number received from the mobile phone 30 of access source against the mobile phone number contained in the user information registered in the database. When the mobile phone numbers match, the sex, address, and age in the user information are compared with the sex, location, and age in the advertisement management information 171 designated by the advertiser, and it is determined which advertisement information will be downloaded (S236).

Also, the service server 10 having received the access information and the mobile phone number requests the advertisement information from the advertisement information server 60, and acquires the requested advertisement information from the advertisement information server 60 (S237).

Then, the service server 10 generates download data by merging the advertisement information acquired from the advertisement information server 60 with the registration information (S238), and performs a download to the mobile phone 30 (S239) of access source.

At the same time, the mobile phone 30 outputs the downloaded advertisement information and registration information (S241).

In addition, the service server 10 performs billing for the registration service usage charge (S242).

In the billing process of the second embodiment, the advertisement information to be downloaded is determined according to the user information (such as sex, address, and age) related to the user of access source, the discount information corresponding to the downloaded advertisement information is referenced, and discount processing is performed according to the referenced result. For example, according to the first table information 171 shown in FIG. 4A, when access has occurred from the mobile phone 30 of a user who corresponds to the following conditions: “male”; “Yokosuka-shi, Kanagawa” (or “Hashirimizu 1-chome, Yokosuka-shi, Kanagawa”); “20s to 30s”; and “Jan. 1, 2003 to Dec. 15, 2003”, the advertisement information as the advertisement ID “100001” is acquired from the advertisement information server 60 according to the advertisement path. Then, the information is downloaded to the mobile phone 30 of access source, and discount processing is performed according to the discount information associated with the advertisement information. At the same time, the advertiser ID “988” with which the advertisement ID “100001” is associated is specified according to the third table information 173 shown in FIG. 4C, and the accumulated charge points for the corresponding advertiser ID “988” in the second table information 172 shown in FIG. 4B continue to be added depending on the number of access instances or the number of accessed users. Furthermore, when access occurs from the mobile phone 30 of a user to whom the following conditions: “female”; “Kitahiroshima-shi, Hokkaido” (or “Koyo-cho 3-chome, Kitahiroshima-shi, Hokkaido”); “40s to 50s”; and “Jan. 1, 2003 to Feb. 15, 2003”, the advertisement information as the advertisement ID is “100002” is acquired from the advertisement information server 60 according to the advertisement path. Then, the information is downloaded to the mobile phone 30 of access source, and discount processing is performed according to the discount information associated with the advertisement information. At the same time, the advertiser ID “989” with which the advertisement ID “100002” is associated is specified according to the third table information 173 shown in FIG. 4C, and the accumulated charge points for the corresponding advertiser ID “989” in the second table information 172 shown in FIG. 4B continue to be added to according to the number of access instances (or the number of accessed users). According to the discounted portion of the service usage charge, billing of the advertiser is performed according to the second table shown in FIG. 4B.

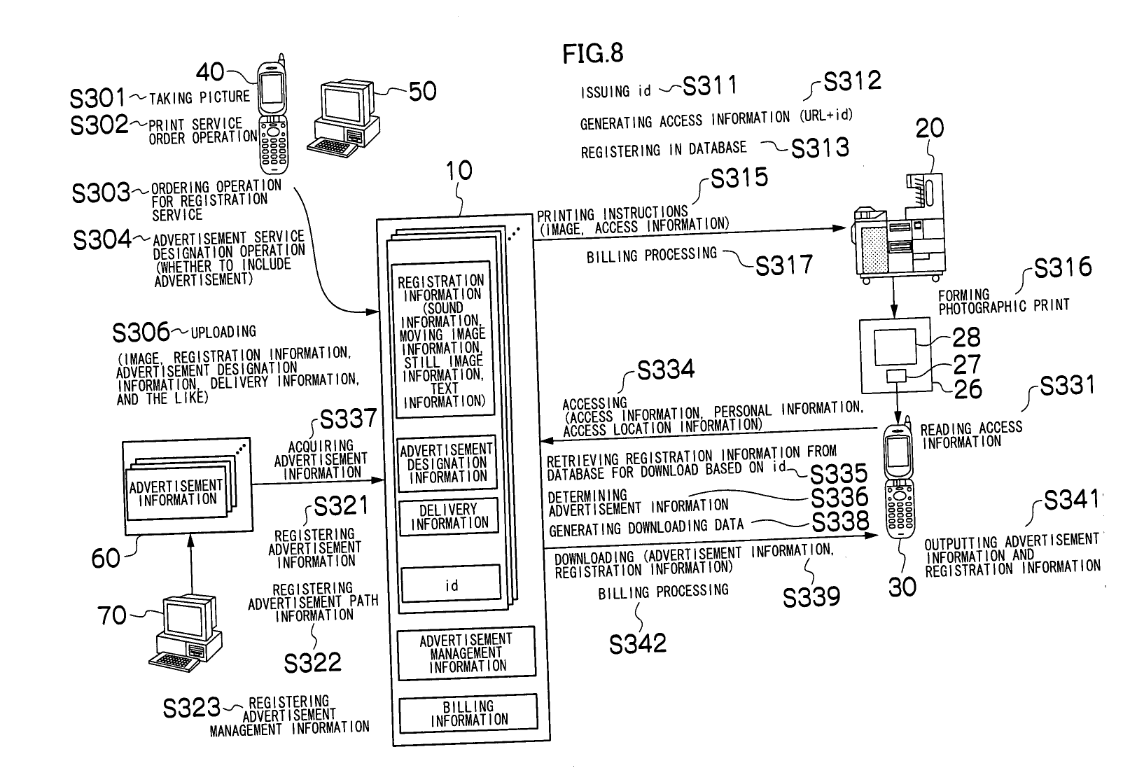

Next, the sequence of service processing according to a third embodiment will be described by using the flowchart in FIG. 8.

In FIG. 8, as similar to the first embodiment, the user ordering the print photographs an object by using the mobile phone 40 (S301), performs the ordering operation for the print service (S302), and then performs the ordering operation for the registration service (S303) and the advertisement designation operation (S304). When the prescribed transmission operation is performed, the order information is uploaded via the network 90 from the mobile phone 40 to the service server 10 (S306). Herein, the order information contains image to be printed, the registration information (such as sound information, text information, moving image information, and the like), the advertisement designation information, and the photographic print delivery information. At this time, the advertise designation information includes information indicating presence or absence of advertisement.

Incidentally, an image may be taken with a digital camera (S301), and the order information may be uploaded from a PC 50 (S302, S303, S304, and S306).

The service server 10 having received the upload of the order information issues the identification information id for each the images to be printed (S311), generates the access information (S312), and then registers the uploaded information in a database (S313). In addition, the image and the access information are transmitted from the service server 10 to the printer 20 (S315), and the photographic print 26 is formed by the printer 20 (S316). The access information in this arrangement is in the form of a two-dimensional barcode 27, and is printed together with the printed image 28 on the same printing medium. Furthermore, the service server 10 performs billing for the print service usage charge (S317).

While the order information is uploaded to the service server 10 in this manner, the advertisement information is uploaded from the advertiser terminal device 70 to the advertisement information server 60, and then is registered in the database (not shown) of the advertisement information server 60 (S321).

An advertisement path necessary for the service server 10 to acquire the advertisement information on the advertisement information server 60 via the network 90 is then registered in the database of the service server 10, as part of the advertisement management information (S322).

In addition, when advertisement setting information, such as the advertisement target, the advertising time period, the advertisement points limit, and the like, are inputted from the advertiser terminal device 70, the setting information is transferred to the service server 10 via the advertisement information server 60, and then is registered in the database of the service server 10 as a part of the advertisement management information (S323).

Herein, the terminal device 70 receives a setting which indicates that specified people are to form the advertisement target or that unspecified people are to form the advertisement target. Additionally, in the case in which specified people are to form the advertisement target, the terminal device 70 receives settings for the sex, location, and age of the advertisement target. In this case, settings indicating “specified” or “not specified” are received for each of the respective items, “sex”, “location”, and “age”. For example, in the case in which the advertisement target is to be set to females only without specifying the location and age, the “sex” item is set to female, and the location and age items are set to “not specified”.

Incidentally, the advertisement management information that can be set from the advertiser terminal device 70 is not limited to settings relating to the advertisement target, and the “advertisement points limit” illustrated in FIG. 4B, for example, can also be set from the advertiser terminal device 70.

When the advertisement information and advertisement setting information (as a part of the advertisement management information) is inputted from the advertiser terminal device 70, table information as shown in FIGS. 4A, 4B and 4C is created in the database of the service server 10.

Further, the information that can be inputted from the advertiser terminal device 70 is not limited to advertisement information and advertisement management information. Service usage charge discount information may also be inputted from the advertiser terminal device 70 and transferred to the service server 10 via the advertisement information server 60, so that it can be registered in the database of the service server 10 as a part of billing information.

Next, according to the third embodiment, the sequence of processing to download the advertisement information and the registration information from the service server 10 to the mobile phone 30 of the destination distributing the photographic print 26 will be described.

First, when the two-dimensional barcode 27 on the photographic print 26 is read by the mobile phone 30 of user to whom the photographic print 26 will be distributed (S331), the access information, the user information (personal information of the user to whom the photographic print will be distributed) registered in advance in the mobile phone 30, and the access location information indicating the current position detected by the mobile phone 30 are transmitted to the service server 10 from the mobile phone 30, and then the service server 10 receives the transmitted access information, user information, and access location information (S334). The access information contains the identification information id.

In this time, the service server 10 having received the access information, the user information, and the access location information extracts the identification information id contained in the access information, and then retrieves from the database the registration information relating to the identification information id thus extracted (S335).

Also, according to the user information (such as sex, age, and other information), the access location information received from the mobile phone 30 of access source, and the advertisement management information (such as sex, location, age, and the like) managed by its own database, the service server 10 determines the advertisement information necessary for downloading (S336), requests the advertisement information from the advertisement information server 60, and retrieves the requested advertisement information from the advertisement information server 60 (S337).

Then, the service server 10 generates download data by merging the advertisement information acquired from the advertisement information server 60 with the registration information retrieved from its own database (S338), and performs a download to the mobile phone 30 of access source (S339). The mobile phone 30 outputs the advertisement information and registration information thus downloaded (S341).

Additionally, even if the service server 10 is not able to acquire personal information of the user or access location information from the mobile phone 30, advertisement information in which unspecified people is set as the advertisement target is still downloaded to the mobile phone 30 of the unspecified person, according to the advertisement management information.

In addition, the service server 10 performs billing for the registration service usage charge (S342).

According to the third embodiment, the advertisement information to be downloaded is determined according to the user information (such as sex, age, and the like) and the access location uploaded from the mobile phone 30 of user as access source, the discount information corresponding to the downloaded advertisement information is referenced, and then discount processing is performed according to the referenced result.

Furthermore, as for the access location information, the position information detected by using a GPS (Global Positioning System) is transmitted to the service server 10 as the access location information when the mobile phone is capable of detecting a position by using a GPS. For example, when access is performed from Nakameguro, the access location information indicating Nakameguro is transmitted to the service server 10. Then, the advertisement information for a nearby pizza restaurant that would be desirable to the user is merged with the registration information and downloaded. For example, sound information that constitutes the registration information is played back after the advertisement information relating to the desirable pizza restaurant is displayed.

Additionally, for example, when a commercial for a specified women's information magazine is set by an advertiser to be displayed to women in their early 20s as the advertising target, the women's magazine commercial is sent only to the mobile phones 30 of women in their early 20s.

In addition, for example, in the case of an advertisement for a theme park attraction, a configuration may be adopted in which information or multimedia information relating to the attraction is transmitted.

When the advertised contents has a so-called “R-rating,” the advertisement can be set so as not to go to the mobile phones 30 of users who are under 18.

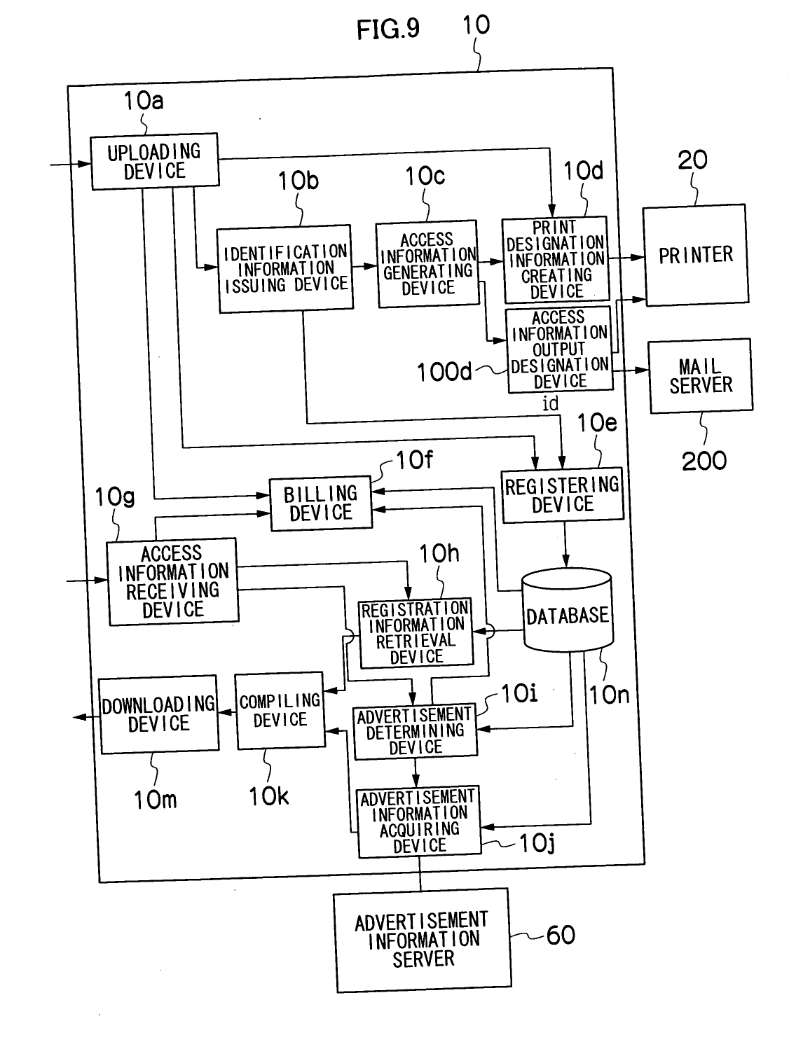

FIG. 9 is an approximate block diagram showing the approximate composition of a service server 10 according to a fourth embodiment. As shown in FIG. 9, the service server 10 comprises: an input device 100a; an identification information issuing device 10b; an access information generating device 10c; a print designation information creating device 10d; an access information output designation device 100d; a registering device 10e; a billing device 10f; an access information receiving device 10g; a registered information retrieval device 10h; an advertisement determining device 10i; an advertisement information acquiring device 10j; a compiling device 10k; a downloading device 10m; and a database 10n. In FIG. 9, compositional elements which are the same as shown in FIG. 5 are labeled with the same reference numerals and detailed description thereof is omitted here.

The service server 10 according to the fourth embodiment also has a function for providing a service of storing and delivering digital contents (hereafter simply referred to as “contents”) which are unrelated to photographic print orders, as well as providing services according to photographic print orders as described previously in the first to third embodiments. Functions described previously are not described again here.

The input device 100a has a function for receiving the input of various types of contents which are unrelated to photographic prints (“registered information”), in addition to the function for receiving photographic print order information of the uploading device 10a shown in FIG. 5.

For example, it is preferable to adopt moving image information, such as television programs, video images, music videos, and the like, as contents inputted to the input device 100a. The contents are not limited to moving image information of this kind, and various other types of contents, such as sound information, text information, vector graphics animation information, and the like, can also be inputted to the input device 100a.

As the mode for inputting contents to the input device 100a, there are a mode in which contents is inputted from the PC 50 of the contents creator via the network, a mode in which contents generated on the mobile phone 40 of a general user is inputted from the mobile phone 40 via the network, and a mode in which contents is inputted by a removable media (not illustrated) such as a memory card, optical disk, or the like.

In addition to the function for inputting contents, the input device 100a has a function for inputting advertisement setting information (such as information indicating the presence or absence of an advertisement, advertisement selection information, or the like), contents discount information (such as information indicating the output method of the access information, or the like), and user information for contents download destination (such as age, sex, address, and the like), as required.

When contents is inputted to the input device 100a, the identification information issuing device 10b issues identification information id which identifies contents. The access information generating device 10 generates access information necessary for the mobile phone 30 of the user to whom contents is to be downloaded to acquire contents via the network. Herein, the access information includes identification information id which is issued by the identification information issuing device 10b.

The access information output designation device 100d designates output of the access information generated by the access information generating device 10c, to the mail server 200 or the printer 20.

The access information output designation device 100d creates, for example, an electronic mail addressed to the user, to which the access information is attached, and it sends this electronic mail to the mail server 200 forming an access information output device. In addition, the access information output designation device 100d creates designation information for recording the access information on a prescribed recording medium as a two-dimensional barcode, for example, and then sends the created designation information to the printer 20 forming an access information output device.

The registering device 10e registers contents, advertisement designation information, and discount information, in association with the identification information id in the database 10n.

The access information receiving device 10g receives access information which is inputted to the mobile phone 30, and access related information which includes at least one of personal information corresponding to the user of access source and access location information, from the access source mobile phone 30.

The registered information retrieval device 10h, as a contents acquiring device, selects and acquires contents corresponding to the access information, according to the access information received from the mobile phone 30, from the database 10n.

The advertisement determining device 10i determines the advertisement information corresponding to the access related information, according to the access related information which is received from the mobile phone 30, and on the advertisement management information which is managed in the database 10n.

The advertisement information acquiring device 10j selects and acquires advertisement information corresponding to the access related information received from the mobile phone 30 according to the determination result of the advertisement determining device 10i, from the advertisement information server 60 or the database 10n.

The compiling device 10k combines contents acquired by the registered information registering device 10h with contents acquired by the advertisement information acquiring device 10j, and compiles data to be downloaded to the mobile phone 30 of access source.

The downloading device 10m downloads the download data compiled by the compiling device 10k, to the mobile phone 30 of access source.

The billing device 10f searches for the discount information corresponding to the downloaded advertisement information from the database 10n, and discounts or waives the service usage charge which is related to the registration of contents and the delivery of contents, according to this discount information.

Incidentally, briefly describing the relationship between the constituent elements of the service server 10 shown in FIG. 9 and the specific structure of the service server 10 shown in FIG. 3, the communication unit 11 and controller 12 shown in FIG. 3 comprises the input device 100a, access information receiving device 10g, advertisement information acquiring device 10j and downloading device 10m shown in FIG. 9. In addition, the controller 12 shown in FIG. 3 comprises the identification information issuing device 10b, access information generating device 10c, print designation information creating device 10d, access information output designation device 100d, registering device 10e, registered information retrieval device 10h, advertisement determining device 10i, and compiling device 10k in FIG. 9. Furthermore, the database 10n shown in FIG. 9 is composed of the registered information database 13, user information database 14, billing information database 15, map information database 16, and advertisement management information database 17 shown in FIG. 3.

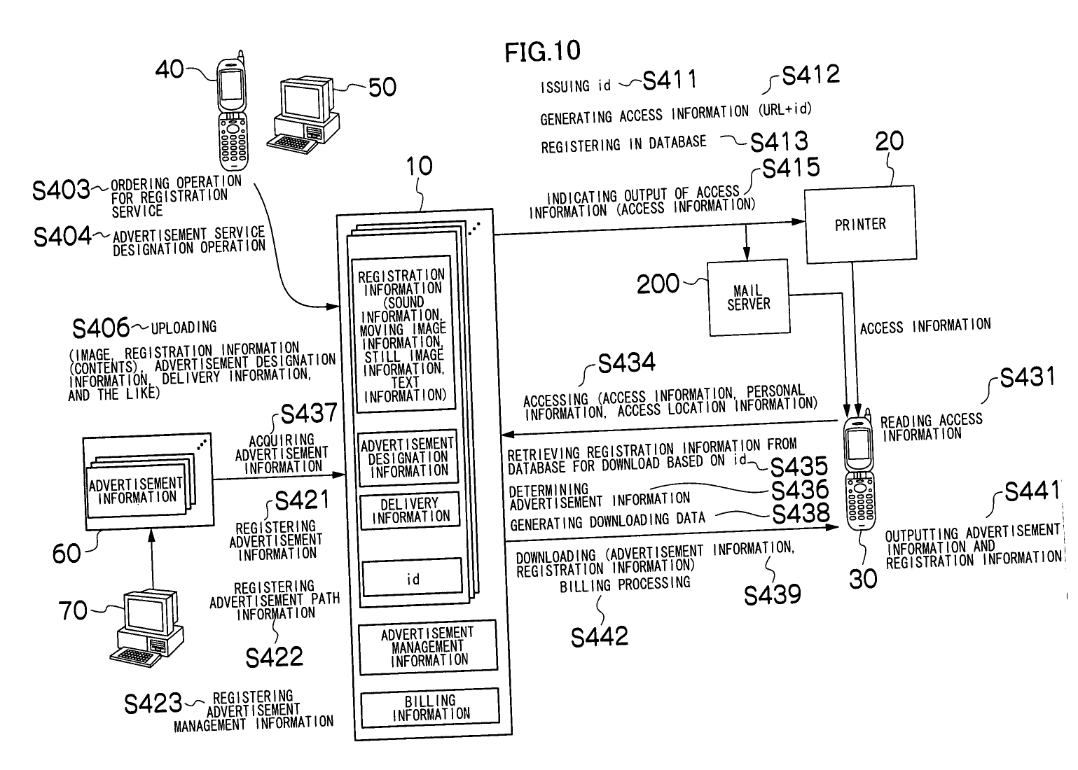

Next, a sequence of service processing according to the fourth embodiment is described with reference to FIG. 10.

In FIG. 10, order operations for a registration service are made at the PC 50 (S403).

Herein, the registration service is a service which stores contents which are received from the PC 50 of a contents creator into the database 10n of the service server 10 for a prescribed time period, and which also delivers the stored contents to the mobile phone 30 of a general user.

In addition, specification operations for an advertisement service are made at the PC 50 (S404).

Herein, an advertisement service is a service that discounts or waives the service usage charge that should be billed to a downloading user by downloading prescribed advertisement information in addition to contents, when contents managed in the database 10n of the service server 10 is downloaded to the mobile phone 30 of a user forming the download destination of contents.

When a prescribed transmission operation is performed, order information which includes contents, advertisement designation information, and discount information is uploaded from the PC 50 to the service server 10 (S406).

Herein, the advertisement designation information includes information indicating the presence or absence of an advertisement. In addition, the discount information includes information indicating the output method for the access information.

Incidentally, it is also possible to upload contents from the mobile phone 40 of a general user who wishes to register contents (S403, S404, and S406).

The service server 10 having received the upload of the order information issues identification information id for each of contents (S411), generates access information (S412), and registers the uploaded information in the database 10n (S413).

In addition, the access information is output by a method specified according to the discount information (S414). For example, in the case in which the access information is to be delivered by electronic mail, an electronic mail to which the access information is attached is sent to the mail server 200. Additionally, in the case in which access information converted into a two-dimensional barcode is to be delivered, the printer 20 is instructed to output the access information converted into a two-dimensional barcode.

In this manner, while the order information including contents is uploaded to the service server 10, the advertisement information is uploaded from the advertiser terminal device 70 to the advertisement information server 60, and then is registered in the database of the advertisement information server 60 (S421). Then, an advertisement path necessary for the service server 10 to acquire the advertisement information on the advertisement information server 60 via the network 90 is registered in the database of the service server 10 (S422). In addition, when advertisement setting information, such as the advertisement target, the advertising time period, the advertisement points limit, and the like, are inputted from the advertiser terminal device 70, the advertisement setting information is transferred to the service server 10 via the advertisement information server 60, and then is registered in the database of the service server 10 as a part of the advertisement management information (S423).

Next, according to the fourth embodiment, the sequence of processing in which the service server 10 downloads the advertisement information and contents to the mobile phone 30 will be described.

When access information is inputted at the mobile phone 30 of the user forming the download destination of the contents (S431), the access information, user information which is previously registered in the mobile phone 30 (personal information for the user to whom the photographic print is to be delivered), and access location information which indicates the current position determined by the mobile phone 30 are sent from the mobile phone 30 to the service server 10, and then the access information, user information, and access location information are received by the service server 10 (S434). The access information includes the identification information id.

The service server 10 having received the access information, the user information, and the access location information extracts the identification information id contained in the access information, and selects and acquires the contents (registered information) relating to the extracted identification information id, from the database 10n (S435).

The service server 10 determines the advertisement information to be downloaded according to the user information (such as sex, age, and other information), access location information which is received from the mobile phone 30 of access source, the advertisement management information (such as sex, location, age) which is managed by the database 10n of the service server 10 (S436). After that, the service server 10 requests the advertisement information from the advertisement information server 60, and selects and acquires the requested advertisement information from the advertisement information server 60 (S437).

Then, the service server 10 generates download data by combining the advertisement information acquired from the advertisement information server 60 with the contents (registered information) (S438), and performs a download to the access source mobile phone 30 (S439). Thus, the mobile phone 30 outputs the advertisement information and registered information downloaded (S441).

Incidentally, even if the service server 10 is not able to acquire personal information of the user or access location information from the portable telephone 30, advertisement information having unspecified people set as the advertisement target is still downloaded to the portable telephone 30 of the unspecified person according to the advertisement management information.

In addition, the service server 10 performs billing in respect of the registration service usage charge (S442).

According to the first through fourth embodiments, examples of recording the access information on the photographic print 26 as a two-dimensional barcode are described above, but the present invention is not limited to this configuration, and the access information may also be written into an IC tag formed in the paper. In this case, it is preferable to provide the printer 20 with a nonlinear writing device that writes the access information in nonlinear fashion in the IC tag (also referred to as RFID (Radio Frequency Identification)). Also, it is preferable to provide the mobile phone with a nonlinear reading device which reads the access information from the IC tag in nonlinear fashion.

In addition, a composition may be adopted in which the access information is embedded and recorded as a digital watermark in the image on the photographic print 26. In this case, it is preferably to provide the mobile phones 30 and 40 with the capability of reading digital watermark information.

The present invention is also not limited to mobile phones 30 and 40. PDA (Personal Digital Assistants) and other communication terminals may also be adapted to the present invention.

It should be understood, however, that there is no intention to limit the invention to the specific forms disclosed, but on the contrary, the invention is to cover all modifications, alternate constructions and equivalents falling within the spirit and scope of the invention as expressed in the appended claims.

1. A server, comprising:
an uploading device which receives an uploading of an image to be printed;
a first database which manages additional information related to the image;
an access information generating device which generates access information necessary in order for a user terminal to acquire the additional information via a network;
a print instruction information creating device which creates instruction information whereby the access information and the image are recorded on a same print medium by a prescribed printer;
an access information receiving device which receives the access information inputted to the user terminal according to the print medium from the user terminal;
a second database which manages advertisement information; and
a downloading device which, when the access information is received from the user terminal, downloads the advertisement information to the user terminal of an access source, the advertisement information being downloaded together with the additional information corresponding to the access information.

2. The server as defined in claim 1, further comprising:
a third database which manages service usage charge discount information in association with each of items of the advertisement information; and
a billing device which performs billing a service usage charge, wherein:
the uploading device receives a selection of the advertisement information to be downloaded to the user terminal of the access source when uploading of the image, the selection being selected from among the advertisement information managed by the second database; and
the billing device performs discounting or waiving of the service usage charge according to the discount information corresponding to the selected advertisement information.

3. The server as defined in claim 1, wherein:
the access information receiving device receives personal information of the user of access source received from the user terminal of the access source; and
the downloading device selects the advertisement information on basis of the personal information, and downloads the selected advertisement information to the user terminal of the access source.

4. The server as defined in claim 3, wherein the personal information includes at least one of sex, age, and address of the user.

5. The server as defined in claim 1, further comprising:
a third database which manages discount information of a service usage charge in association with each of items of personal information of the user of the access source; and
a billing device which performs discounting or waiving of the service usage charge according to the personal information which is received from the user terminal of the access source, and the discount information which is managed by the third database.

6. The server as defined in claim 3, further comprising:
a third database which manages discount information of a service usage charge in association with each of items of personal information of the user of the access source; and
a billing device which performs discounting or waiving of the service usage charge according to the personal information which is received from the user terminal of the access source, and the discount information which is managed by the third database.

7. The server as defined in claim 1, wherein the downloading device selects the advertisement information according to an access location of the user terminal of the access source, and downloads the selected advertisement information to the user terminal of the access source.

8. The server as defined in claim 1, further comprising:
a third database which manages discount information of a service usage charge in association with map information for indicating an access location in which the user terminal of the access source is located; and
a billing device which performs discounting or waiving of the service usage charge, according to the access location and the discount information managed by the third database.

9. The server as defined in claim 6, further comprising:
a fourth database which manages discount information of a service usage charge in association with map information for indicating an access location in which the user terminal of the access source is located; and
a billing device which performs discounting or waiving of the service usage charge, according to the access location and the discount information managed by the third database.

10. The server as defined in claim 1, further comprising a third database which manages personal information of the user of an access source of user registered by the user who uploads the image, wherein:
when access is received from the user terminal of the access source, the downloading device selects the advertisement information according to the personal information managed by the third database, and downloads the selected advertisement information to the user terminal of the access source.

11. The server as defined in claim 10, wherein the personal information includes at least one of sex, age, and address of the user.

12. The server as defined in claim 1, further comprising:
a third database which manages personal information of the user registered by the user who uploads the image;
a fourth database which manages discount information of a service usage charge in association with each of items of the personal information; and
a billing device which performs discounting or waiving of the service usage charge according to information managed by the third and fourth databases when the access information is received from the user terminal of the access source.

13. The server as defined in claim 12, wherein the personal information includes at least one of sex, age, and address of the user.

14. The server as defined in claim 10, further comprising:
a fourth database which manages discount information of a service usage charge in association with each of items of the personal information; and
a billing device which performs discounting or waiving of the service usage charge according to information managed by the third and fourth databases when access information is received from the user terminal of the access source.

15. A server, comprising:
an input device which inputs contents;
a first database which manages the contents inputted by the input device;
an access information output designation device which designates an output of access information necessary for a user terminal to acquire the contents via a network;
an access information receiving device which receives the access information which is inputted to the user terminal and acquires access related information which includes at least one of personal information relating to a user of an access source and access location information;
a second database which manages advertisement information; and
a downloading device which downloads the advertisement information to the user terminal of the access source, the advertisement information being downloaded corresponding to the access related information together with the contents corresponding to the access information.

16. The server as defined in claim 15, wherein:
the contents includes at least one of image information, sound information, and text information; and
the personal information includes at least one of sex, age, and address of the user.

17. The server as defined in claim 15, further comprising:
a third database which manages discount information of a service usage charge in association with each of items of the advertisement information; and
a billing device which performs billing of the service usage charge, wherein:
the input device receives a selection of advertisement information to download to the user terminal of the access source, the selection being selected from among the advertisement information managed by the second database; and
the billing device performs discounting or waiving of the service usage charge according to the discount information corresponding to the selected advertisement information.

18. The server as defined in claim 15, further comprising:
a third database which manages discount information of a service usage charge in association with each of items of the access related information; and
a billing device which performs discounting or waiving of the service usage charge according to the access related information and the discount information managed by the third database, when accessed from a user terminal of an access source by means of the access information.

19. A service method, comprising the steps of:
receiving an upload of an image to be printed;
registering additional information relating to the image in a first database;
generating access information necessary in order for a user terminal to acquire the additional information via a network;
creating instruction information whereby the access information and the image are recorded on a same print medium by a prescribed printer;
receiving access information inputted to the user terminal according to the print medium from the user terminal;
acquiring advertisement information managed by a prescribed second database; and
downloading the advertisement information to the user terminal of the access source, the advertisement information being downloaded together with the additional information corresponding to the access information, when the access information is received from the user terminal.

20. The service method as defined in claim 19, further comprising a step of performing discounting or waiving of the service usage charge according to discount information managed by a prescribed third database.

21. A service method, comprising the steps of:
registering contents in a prescribed first database;
designating an output of access information necessary for a user terminal to acquire the contents via a network;
acquiring access related information including at least one of personal information of the user of the access source and access location information while receiving the access information inputted to the user terminal; and
downloading the advertisement information to the user terminal of the access source, the advertisement information being downloaded corresponding to the access related information together with the contents corresponding to the access information.

22. The service method as defined in claim 21, wherein:
the contents includes at least one of image information, sound information, and text information; and
the personal information includes at least one of sex, age, and address of the user.

23. The service method as defined in claim 21, further comprising a step of discounting or waiving the service usage charge according to discount information managed by a prescribed third database.
